(19) United States
(12) Patent Application Publication
(10) Pub. No.: US 2007/0287757 A1
(43) Pub. Date: Dec. 13, 2007

(54) Method for stabilization of disperse systems

(75) Inventors: Angelika Kuhnle, Osnabruck (DE); Jens Rieger, Ludwigshafen (DE); Yaqian Liu, Ludwigshafen (DE); Stephan Hess, Mannheim (DE); David A. Weitz, Cambridge, MA (US); Chanjoong Kim, Cambridge, MA (US)

Correspondence Address: CONNOLLY BOVE LODGE & HUTZ, LLP, P O BOX 2207, WILMINGTON, DE, 19899, US

(73) Assignees: BASF Aktiengesellschaft, Ludwigshafen (DE); Harvard University

(21) Appl. No.: 11/449,360

(22) Filed: Jun. 8, 2006

(51) Int. Cl. C09K 3/00

(52) U.S. Cl. 516/76

(57) ABSTRACT

A method for stabilization of a disperse system which normally is not stable against sedimentation or creaming comprising the step of adding to said disperse system at least one network-inducing component, e.g. a water-soluble polymer, leads to particularly stable disperse systems.

### FIELD OF THE INVENTION

The following invention relates to a method for stabilization of disperse systems and particularly of emulsions.

### BACKGROUND OF THE INVENTION

As one group of disperse systems, emulsions are heterogeneous systems consisting of two liquids which are not miscible or which have a limited miscibility with one another. These two liquids normally are separated as two phases. In an emulsion as one form of a disperse system, by applying certain levels of energy one of the two liquids is dispersed in the form of very fine droplets in the other liquid. If, for example, one of the liquids is water and the other oil, then an oil-in-water or water-in-oil emulsion is formed. The basic character of such an emulsion (example given milk) is defined by the water component. Contrary to that, in a water-in-oil emulsion (e.g. butter) the basic character is determined by the oil component.

In order to achieve a disperse system in which one phase is more permanently dispersed in the other phase, it is normally necessary to add one or several emulsifiers, which are interface-active substances. These emulsifiers normally have an amphiphilic molecular structure, consisting of a hydrophilic and a lipophilic molecular moiety, which are often separated from one and another by a spacer unit.

In a simple emulsion, finely disperse droplets of one phase, surrounded by an emulsifier shell, are present in the second phase. Emulsifiers lower the tension between the two phases by positioning themselves at the interface between the two liquids. At the phase boundary, they form an oil/water interfacial film which prevents irreversible coalescence of the droplets.

Emulsions are frequently stabilized by natural or synthetic emulsifiers or mixtures thereof. Emulsifiers can traditionally be divided into ionic emulsifiers and non-ionic emulsifiers. The most well-known example of an anionic emulsifier is regular soap, which consists of water-soluble sodium or potassium salts of higher fatty acids. An important example of cationic emulsifiers are quaterny ammonium compounds.

The hydrophilic part of the molecule of non-ionic emulsifiers frequently consists of glycerol, polyglycerol, sorbitants, carbohydrates and/or polyoxyethylene glycols. In most cases, this hydrophilic moiety is linked to the lipophilic molecular moiety via an ester or ether group. The lipophilic part of the molecule usually consists e.g. of fatty alcohols, fatty acids or isofatty acids.

By varying the structure and the size of the polar and non-polar molecular parts and of the spacer part, the lipophilicity and the hydrophilicity of the emulsifier can be varied.

Whereas many emulsions and other disperse systems can be stabilized by using classical emulsifiers and thickeners, certain types of emulsion and other disperse systems can until now not be stabilized as needed. A decisive factor for the stability of an emulsion is the correct choice of the emulsifier and the concentration of emulsifier used in the system. The characteristics and concentrations of all substances present in the system have to be taken into consideration.

Emulsions are an important product in a variety of different fields of use. They are, for example, used for the preparation of food products and cosmetic, dermatological and other pharmaceutical preparations. Food products are often stabilized by natural emulsifiers to stabilize the liquid-liquid or solid-liquid Interfaces. Cosmetic preparations are normally prepared to strengthen or rebuild the natural functions of the skin as barrier against environmental influences. Pharmaceutical compositions usually comprise one or several active principals in an effective concentration and other pharmaceutically acceptable components, e.g. an emulsifier.

Already 100 years ago, emulsions based on paraffin and water were prepared and stabilized by the addition of various salts. It was also described decades ago that a reduction in the required amount of an emulsifier can be achieved by adding other stabilizing agents to the composition. These substances accumulate, for example, at the oil/water phase boundary in the form of a layer. As a result of which coalescence of the disperse phase is prevented. It was observed that microscopic solid particles, for example, can be used to substitute emulsifiers as stabilization agent in emulsions.

However, even when coalescence of the droplets can be prevented by e.g. surfactants, another type of instability can still occur, namely creaming and sedimentation. Disperse systems on earth are under permanent gravitational stress unless the densities of the disperse phase and the continuous phase are exactly matched. If the density of the disperse phase is higher than that of the solvent, after a certain period of time a sediment of colloids is formed. If the density of the disperse phase is lower, the colloids normally cream up. In an ideal case, the creaming or sedimentation of colloids should also be avoided. In order to achieve this, a further component like a thickener is often applied to reduce the speed of creaming or sedimentation.

### SUMMARY OF THE INVENTION

It is one object of this invention to provide with a new method for stabilization of disperse systems, particularly of emulsions and suspensions, against creaming or sedimentation by adding a new network-inducing component. Preferably, emulsions and suspensions which are stable against coalescence or aggregation are further stabilized against creaming or sedimentation.

As network inducing component a compound or a mixture of compounds is understood which induces a network formation of the oil-droplets (or suspension particles) such that no individual droplets or particles can freely cream-up or sediment.

### A BRIEF DESCRIPTION OF THE FIGURES

FIG. 1 illustrates the test results after 1 hour at room temperature.

FIG. 2 illustrates the test results after 5 hours.

FIG. 3 illustrates the test results for the instability of the test emulsions.

FIG. 4 illustrates the stability of the emulsions after 10 minutes.

FIG. 5 illustrates the stability of the emulsions after 2 hours.

FIG. 6 illustrates the creaming profiles as described in example 1 for the test emulsions.

### A DETAILED DESCRIPTION OF THE INVENTION

The invention deals with a method for stabilization of a disperse system (e.g. emulsions or suspensions) which normally is not stable against sedimentation or creaming comprising the step of adding to said disperse system at least one network-inducing component. If the disperse system comprises two liquid phases it is stabilized against creaming by adding to said disperse system at least one network-inducing component. If the disperse system comprises one liquid phase and one solid phase it is stabilized against sedimentation by adding to said disperse system at least one network-inducing component.

In a particular embodiment of the invention, 1 to 30%, preferably 1 to 20%, of one or several emulsifiers and/or 1 to 10%, preferably 5 to 10%, especially 7 to 10% of one or several water-soluble polymers are added to said disperse system as network-inducing component. The percentages are always given by weight with respect to the total weight of the composition.

Preferably, 1 to 20%, especially 10 to 20%, of one or several emulsifiers, is added as network-inducing component to said disperse system. The network-inducing component added to said disperse system can also consist of 1 to 10%, especially 5 to 10% of one or several water-soluble polymers. The network-inducing component added to said disperse system can also consist of one or several emulsifiers and one or several water-soluble polymers.

The method for stabilization of a disperse system according to the invention preferably is used when the disperse system comprises two liquid phases (e.g. oil and water; silicone oil/water). The method for stabilization of a disperse system can also be used when the disperse system comprises one liquid phase and one solid phase (e.g. solid impurities and oil).

In a preferred embodiment for stabilization of a disperse system, 1 to 20% of one or several emulsifiers is added as network-inducing component to said disperse system.

In a further embodiment of the invention, 1 to 10% of one or several water-soluble polymers is added as network-inducing component to said disperse system.

In a particular embodiment of the invention, the stabilization of a disperse system is achieved by adding 1 to 20% of one or several emulsifiers and 1 to 5% of one or several water-soluble polymers as network-inducing component to said disperse system.

Preferably, 10 to 20% of one or several emulsifiers are added as network-inducing component to a disperse system.

Alternatively, 1 to 10% of one ore several water-soluble polymers are added as network-inducing component to said disperse system.

The invention furthermore deals with a method for stabilization of a disperse system, wherein a solution of one or several emulsifiers in water is added as network-inducing component to said disperse system.

As network-inducing component one or several emulsifiers from the group of ethoxylates of alkyl polyethylene glycol ethers can be used. Preferred emulsifiers are from the group of non-ionic surfactants Lutensol (producer: BASF AG) which are added as network-inducing component to said disperse system.

As water-soluble polymers, polymers from the group of polyvinyl alcohols, polyvinyl pyrollidones, polyethylene glycols, polyethylacrylates, polyhydantoines, poly(hydroxyacrylic acids), and polyethylene glycols are added as network-inducing component. Also water-soluble copolymers can be used.

The invention also deals with a disperse system which is stabilized against sedimentation or creaming according to the method as described above.

The network-inducing component can preferably consist of one or several emulsifiers from the group of ethoxylates of alkyl polyethylene glycol ethers, particularly one of the commercially available non-ionic surfactants Lutensol (e.g. Lutensol TO3, TO5, TO6, TO7, TO8, TO10 and TO12 produced by BASF, Germany), polyethylene fatty acid esters, polyethylene alkyl ethers, polyethylene polypropylene alkyl ethers and polypropylene glycol ethers.

Preferred network-inducing components are compounds of formula (I)

R—O(CH₂—CH₂—O)ₙ—H

wherein R is alkyl with 10 to 15 carbon atoms, preferably 12 to 14 carbon atoms, particularly 13 carbon atoms, and

n is from 2 to 30, preferably from 3 to 20.

In a preferred embodiment, R is i-C₁₃H₁₇ and n is 3, 5, 6, 6.5, 7, 8, 10, 12, 15 or 20. These compounds can also be used as mixtures.

The network-inducing component added can also be one or several water-soluble polymers from the group comprising e.g. polyvinyl alcohols, polyvinyl pyrrolidones, polyethylene glycols, polyethyl acrylates, polyhydantoines, poly(hydroxy-acrylic acids), polymethacrylic acids, polypropylene glycols.

According to a preferred embodiment of the invention, a method for stabilization of an oil-in-water emulsion is provided by adding 5 to 20% of an emulsifier and/or 1 to 5% of a water-soluble polymer to this oil-in-water emulsion.

The method for stabilization of disperse systems can be used for the preparation of various food, cosmetic, dermatological or pharmaceutical products. Further co-emulsifiers can also be used (e.g. 0.1 to 1.5% by weight). In principle, emulsifier micelles and/or water-soluble polymers are useful as network-inducing component ac cording to this invention. In order to stabilize the disperse system, the water-soluble polymer induces the formation of a network of the oil-droplets within the system. Whereas in an emulsion for example the small individual droplets are stable against creaming for a certain period of time (depending inter alia on the droplet diameter, the density difference and the viscosity of the system), they tend to become unstable as soon as small clusters (so-called flocs) are formed. With increasing network-inducing component concentration, often the stability of the emulsion first decreases because of the formation of flocs. However, by adding the above mentioned emulsifiers/polymers to the system, the formation of an oil-droplet-network can be induced which stabilizes the emulsion against creaming.

The following water-soluble polymers are particularly useful according to this invention,

polyvinyl alcohols, polyvinyl pyrrolidones, polyethylene glycols, polyethyl acrylates, poly(hydroxy-acrylic acids) and polymethacrylic acids.

The following examples illustrate the present invention. The percentages provided are percentages by weight based on the total weight of the respective preparation.

### EXAMPLES

### Example 1

### Use of Lutensol TO8 as Network-Inducing Component

An oil-in-water-emulsion was prepared at room temperature by using a laboratory homogenizer (Ultra-Turrax T50) with 1 minute of continuous homogenization (10000 rpm). This starting emulsion was prepared by using

28.5 g of silicone oil (plasticizer AK100, producer: Wacker Chemie AG, Munich),

1.5 g of an emulsifier (sodiumdodecylsulfate) and

70 g of water.

For the testing of the stability of the emulsions at room temperature, the following emulsions A, B, C, D, E and F were prepared:

Test A)

50 ml of the emulsion as prepared above and 25 ml of pure water were mixed and homogenized for 3 minutes (800 rmp). The resulting emulsion was transferred in a glass cell for further observation.

Test B)

The same procedure was applied as described under Test A, however, 25 ml of a solution containing 9% of the non-ionic surfactant Lutensol TO8 (producer BASF Aktiengesellschaft, Ludwigshafen) in water was used, such that the final emulsion contains 3% of Lutensol TO8.

Test C)

The same procedure was applied as described under Test A, however, 25 ml of a solution containing 18% of the non-ionic surfactant Lutensol TO8 (producer BASF Aktiengesellschaft, Ludwigshafen) in water was used.

Test D)

The same procedure was applied as described under Test A, however, 25 ml of a solution containing 30% of the non-ionic surfactant Lutensol TO8 (producer: BASF Aktiengesellschaft, Ludwigshafen) in water was used.

Test E)

The same procedure was applied as described under Test A, however, 25 ml of a solution containing 45% of the non-ionic surfactant Lutensol TO8 (producer: BASF Aktiengesellschaft, Ludwigshafen) in water was used.

Test F)

The same procedure was applied as described under Test A, however, 25 ml of a solution containing 60% of the non-ionic surfactant Lutensol TO8 (producer: BASF Aktiengesellschaft, Ludwigshafen) in water was used.

The stability of all six test emulsions was observed for a period of more than 24 hours.

After 1 minute at room temperature all six test emulsions (A. B, C, D, E and F) were stable, no creaming was observed.

After 10 minutes, some creaming was observed for test emulsions A and B.

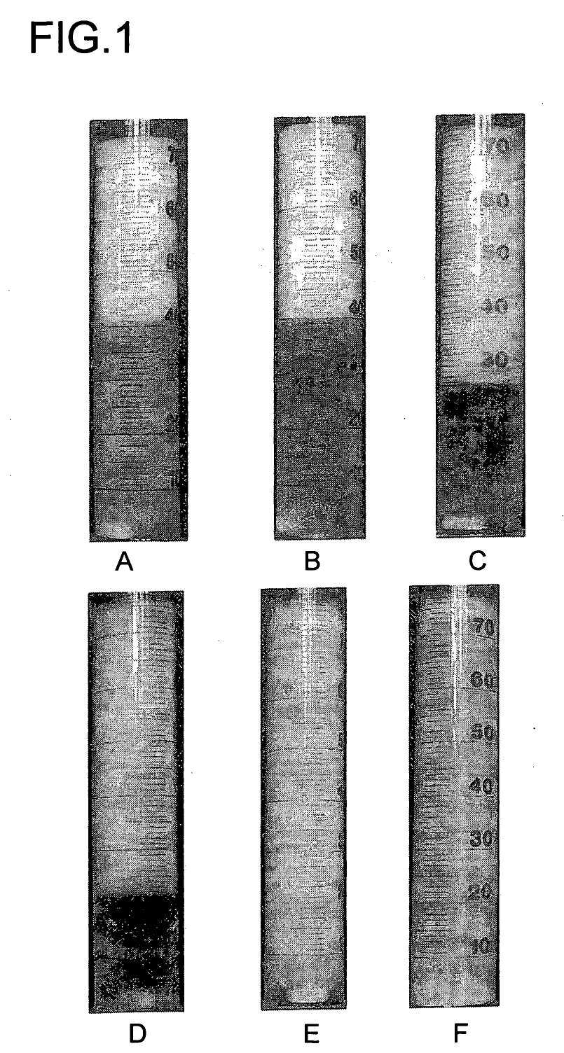

After 1 hour, considerable creaming was observed in test emulsions A, B, C and D. The test results after 1 hour at room temperature are shown in FIG. 1.

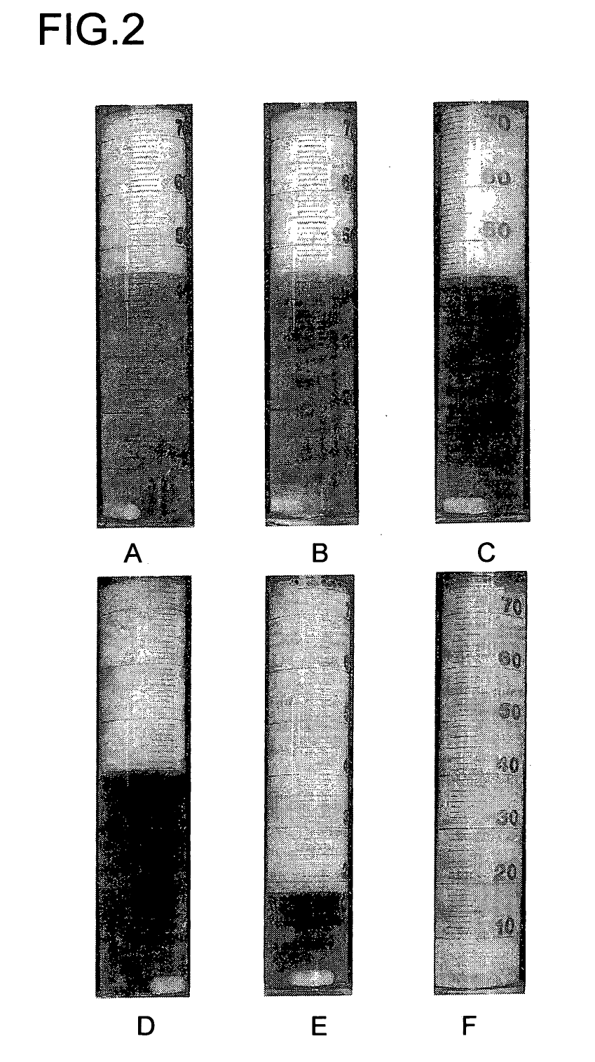

After 5 hours at room temperature, creaming was observed for test emulsions A, B, C, D and E, whereas test emulsion F was stable against creaming. The test results after 5 hours are shown in FIG. 2.

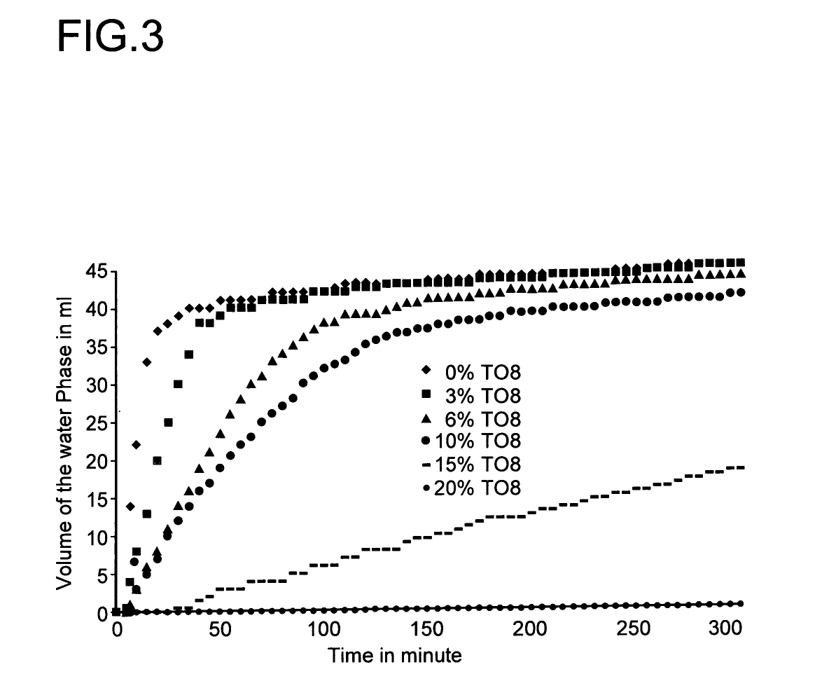

The instability of the test emulsions can be described by measuring the volume of the water phase every 5 minutes. The results are shown in FIG. 3.

As it easily can be seen, the emulsion containing 1% sodiumdodecylsulfate and the highest concentration of Lutensol TO8 was completely stable against creaming for a period of 5 hours.

The emulsion containing 1% of sodiumdodecylsulfate, but containing no network-inducing component was found to be very unstable, whereas the test emulsions B, C, D and E showed some stabilizing effect of the network-inducing component.

### Example 2

### Use of Polyvinyl Pyrrolidone as Network-Inducing Component

An oil-in-water emulsion was prepared at room temperature by using a magnet stirrer (at 800 rpm) for 1 hour of continuous stirring. The starting emulsion was prepared with:

28.5 g paraffin oil (from Roth),

1.5 g Lutensol TO8 (from BASF Aktiengesellschaft) and

70 g of water.

For the testing of the stability of the emulsions at room temperature, the following emulsions A, B, C, D, E, F, were prepared:

Test A)

50 ml of the emulsion as prepared above and 25 ml of pure water were mixed and homogenized for 3 minutes with a magnet stirrer at 800 rpm. The resulting emulsion was transferred in a glass cell for further observation.

Test B)

50 ml of the emulsion as prepared above and 25 ml of solution containing 3% Kollidon 90 F (polyvinyl pyrrolidone; producer BASF Aktiengesellschaft) in water were mixed and homogenized for 3 minutes with a magnet stirrer at 800 rpm, such that the final emulsion contains 1% Kollidon 90 F.

Test C)

50 ml of the emulsion as prepared above and 25 ml of solution containing 9% Kollidon 90 F were mixed and homogenized for 3 minutes with a magnet stirrer at 800 rpm, such that the final emulsion contains 3% Kollidon 90 F.

Test D)

50 ml of the emulsion as prepared above and 25 ml of solution containing 15% Kollidon 90 F were mixed and homogenized for 3 minutes with a magnet stirrer at 800 rpm, such that the final emulsion contains 5% Kollidon 90 F.

Test E)

50 ml of the emulsion as prepared above and 25 ml of solution containing 21% Kollidon 90 F were mixed and homogenized for 3 minutes with a magnet stirrer at 800 rpm, such that the final emulsion contains 7% Kollidon 90 F.

Test F)

50 ml of the emulsion as prepared above and 25 ml of solution containing 30% Kollidon 90 F were mixed and homogenized for 3 minutes with a magnet stirrer at 800 rpm, such that the final emulsion contains 10% Kollidon 90 F.

The stability of all six test emulsions A, B, C, D, E and F was observed for a period of 24 hours.

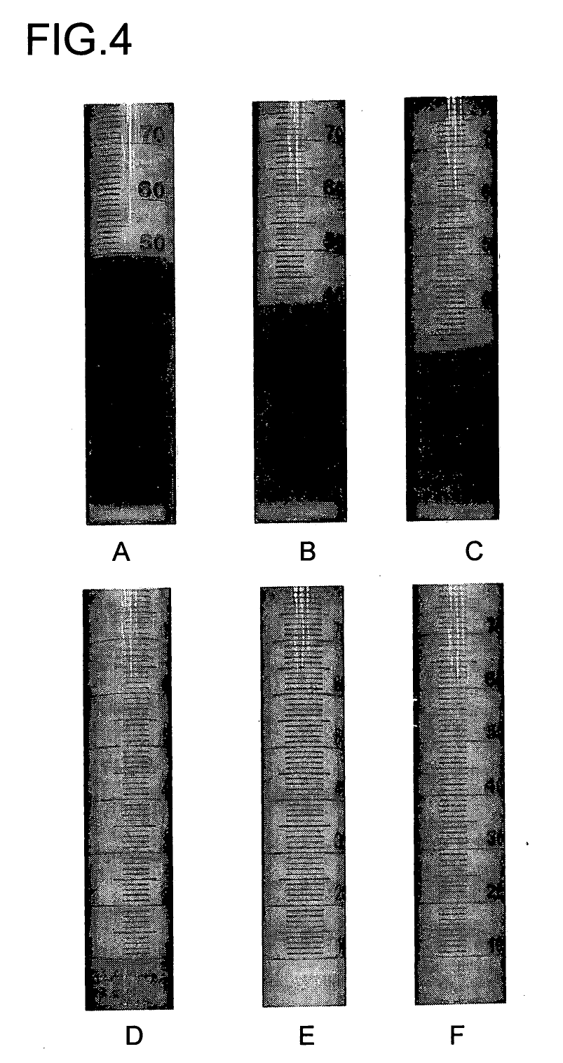

After 10 minutes creaming was observed in test emulsions A, B, C and D (see FIG. 4).

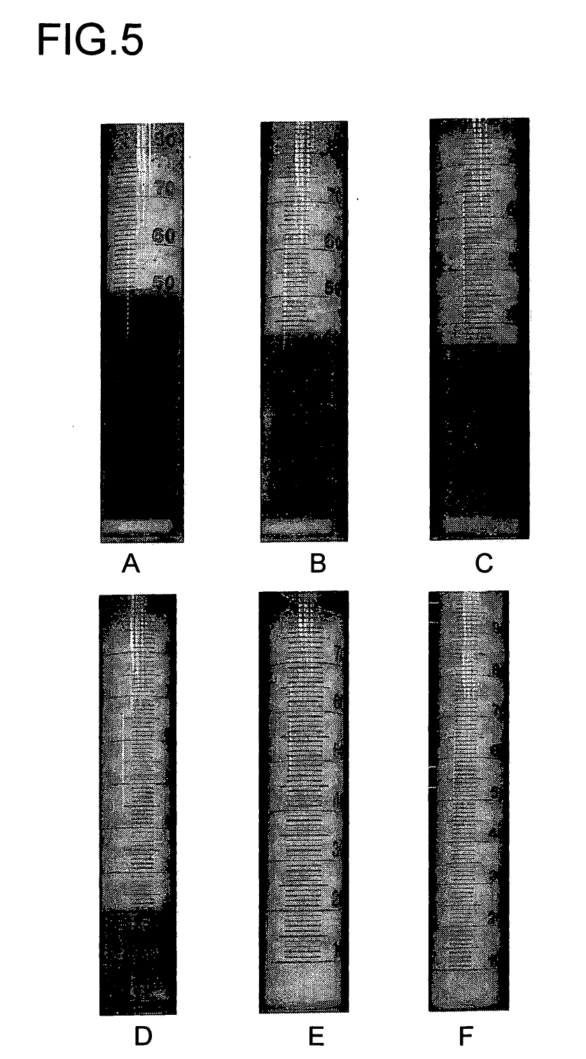

After 2 hours creaming was observed In test emulsions A, B, C and D, emulsions E and F were still stable against creaming (see FIG. 5).

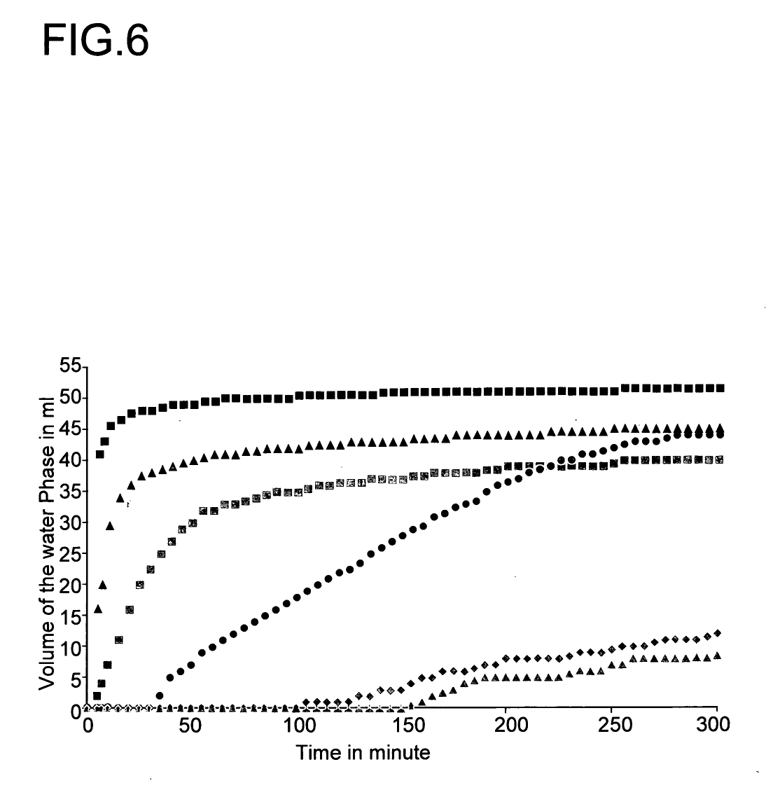

The creaming profiles (as described in example 1) for the test emulsions are shown in FIG. 6.

We claim:

1. Method for stabilization of a disperse system which normally is not stable against sedimentation or creaming comprising the step of adding to said disperse system at least one network-inducing component.

2. Method for stabilization of a disperse system according to claim 1, wherein the disperse system comprises two liquid phases and is stabilized against creaming by adding to said disperse system at least one network-inducing component.

3. Method for stabilization of a disperse system according to claim 1, wherein the disperse system comprises one liquid phase and one solid phase and is stabilized against sedimentation by adding to said disperse system at least one network-inducing component.

4. Method for stabilization of a disperse system according to claim 1, wherein 1 to 30% of one or several emulsifiers and/or 1 to 10% of one or several water-soluble polymers are added as network-inducing component to said disperse system.

5. Method for stabilization of a disperse system according to claim 1, wherein 1 to 20% of one or several emulsifiers is added as network-inducing component to said disperse system.

6. Method for stabilization of a disperse system according to claim 1, wherein 1 to 10% of one or several water-soluble polymers is added as network-inducing component to said disperse system.

7. Method for stabilization of a disperse system according to claim 1, wherein 1 to 20% of one or several emulsifiers and 1 to 10% of one or several water-soluble polymers is added as network-inducing component to said disperse system.

8. Method for stabilization of a disperse system according to claim 1, wherein 10 to 20% of one or several emulsifiers are added as network-inducing component to said disperse system.

9. Method for stabilization of a disperse system according to claim 1, wherein 5 to 10% of one ore several water-soluble polymers are added as network-inducing component to said disperse system.

10. Method for stabilization of a disperse system according to claim 1, wherein a solution of one or several emulsifiers in water is added as network-inducing component to said disperse system.

11. Method for stabilization of a disperse system according to claim 1, wherein one or several emulsifiers from the group of ethoxylates of alkyl polyethylene glycol ethers are added as network-inducing component to said disperse system.

12. Method for stabilization of a disperse system according to claim 1, wherein one or several emulsifiers from the group of non-ionic surfactants Lutensol are added as network-inducing component to said disperse system.

13. Method for stabilization of a disperse system according to claim 1, wherein one or several water-soluble polymers from the group of polyvinyl alcohols, polyvinyl pyrollidones, polyethylene glycols, polyethylacrylates, polyhydantoines, poly(hydroxyacrylic acids), and polyethylene glycols are added as network-inducing component to said disperse system.

14. Method for stabilization of a disperse system according to claim 1, wherein the network-inducing component is added to a disperse system which already contains 0.1 to 1.5% of an emulsifier.

15. Disperse system stabilized against sedimentation or creaming prepared according to the method as claimed in claim 1.
